(19) United States
(12) Patent Application Publication
(10) Pub. No.: US 2016/0275763 A1
(43) Pub. Date: Sep. 22, 2016

(54) Device for Prevention of Beverage Tampering

(71) Applicants: Susan WOODFIN, New Orleans, LA (US); Marcus SCOTT, Atlanta, GA (US)

(72) Inventor: Susan Woodfin, New Orleans, LA (US)

(21) Appl. No.: 14/392,123

(22) PCT Filed: Jun. 25, 2014
(86) PCT No.: PCT/US14/44025

§ 371 Date: Dec. 23, 2015

Related U.S. Application Data
(60) Provisional application No. 61/839,554, filed on Jun. 26, 2013.

(51) Int. Cl. G08B 13/06; G07C 9/00; B65D 25/20

(52) U.S. Cl. CPC G08B 13/06; B65D 25/20; G07C 9/0069; G07C 2009/00984; G07C 2009/00769

(57) ABSTRACT

The invention allows one securely protect their drink from tampering by others at a social gathering. The invention mainly consists of a personalized tampering device that forms a removable secure barrier over a beverage and a means for arming or disarming said device. The invention is powered and has on/off, armed/disarmed, and safe/duress sense indicators for a user.

### CROSS-REFERENCE TO RELATED APPLICATIONS

Not Applicable

### STATEMENT REGARDING FEDERALLY FUNDED RESEARCH

Not Applicable REFERENCE TO A MICROFICHE APPENDIX

Not applicable

### BACKGROUND OF INVENTION

1. Field of the Invention/Technical Field

The present invention is in the technical field of Receptacles 220: More particularly, the present invention is in the technical field of Closures 200.

2. Description of Related Art/Background Art

There exist varieties of can protectors and cup accessories for the purpose of prohibiting the entry of foreign objects into a beverage, protecting the consumer from burns or discomfort, and preventing spills. A search of prior and related art resulted in the following United States patents: United States Patent US2004/0256389 A1 is a canned drink protective cap, constructed of a single piece of thermoplastic material which is molded onto the drink can during the packaging process. The canned drink cap has a tab extending from its side which is pulled to break the seal and remove the cap so that the can may be opened and its contents consumed. The purpose of the protective cap is to hermetically seal the top of the drink can, thus ensuring that it remains clean and hygienic while in transport and storage.

Once the seal is broken and the cap is removed, it cannot be replaced; therefore the canned drink protective cap is only useful before the can is opened and the drink is consumed. The design is also limited for use with standard drink cans and not for use with other drinking containers such as glasses, bottles or mugs.

U.S. Pat. No. 3,399,780 is a lip protector device for use with a drinking glass or other similar vessel, and consisting of two main parts: a base and a set of connector arms. The base is a flat kidney shaped platform that covers a portion of the glass opening. The base can be grated or solid with a toothed lower edge so that when the glass is tipped for drinking, the liquid will flow and the ice cubes are retrained, thus protecting the drinker's lips and teeth. The connector arms flank the base at one end and rise up vertically with a clip apparatus on the other end. The clip apparatus is generally and inverted U-shaped tubular contraption with a slightly indented opening so that it can fit securely on the edge of most drinking glasses. This construction allows for the base to sit inside the glass so that the drinker may drink from the lip of the glass without interference from the apparatus. While this invention may provide for the protection of lips and teeth from unwanted intrusion of ice cubes and other solid matter in a beverage, it does not protect the consumer from unwanted substances entering the beverage.

U.S. Pat. No. 4,537,326, U.S. Pat. No. 5,887,742, U.S. Pat. No. 6,722,518 and U.S. Pat. No. 5,402,904 are all largely similar form and function, generally as protectors for drink openings, for use mainly with standard beverage cans. They are generally comprised of a cover with a plurality of small openings such as holes or slots, and an apparatus for securing the filtering cover onto the can. The cover is placed over the can's opening so that the drinker sips the beverage through the aforementioned openings.

The main aim of these inventions is to prohibit insects from entering the open beverage, particularly in an outdoor environment. Although the cover openings may be too small for most insects to pass through, they do not prohibit smaller particles or liquids from entering or being added to the beverage through the filtering cover. Additionally, the four aforementioned inventions may be removed and replaced with ease and without any indication, allowing for malicious intent without warning.

U.S. Pat. No. 5,765,716 is a cup protector comprising of a sleeve and lid. The sleeve is hollow and circular in design with a tapered lower end that conforms to the taper of a standard portable hot beverage cup. The outer side of the sleeve is corrugated to provide for a hand grip. The lid has a small opening on its top through which the beverage can be consumed, and a protruding bottom rim that snaps over the lip of a standard hot beverage cup. The base of the lid is affixed to the sleeve with a flexible tether. U.S. Pat. No. 5,765,716 provides for the insulation of hot beverages; as well as, protection against burns or discomfort that could result from holding or transporting a cup of hot drink. It too is easily removable and replaceable and does not provide any protection against malicious acts, such as the intentional spiking of a beverage.

U.S. Pat. No. 6,053,352 is similar to U.S. Pat. No. 5,765,716 in that it is a sleeve, hollow and circular in structure, which is designed to provide extra grip traction and insulation for a variety of beverage containers, such as cups, soda bottles, etc. It does not provide any coverage for the container, nor does it prohibit foreign objects from entering or being placed in the beverage.

### BRIEF SUMMARY OF THE INVENTION

The invention allows an inexpensive means to securely protect a persons beverage from tampering by others. The device mainly consists of two components a tampering device and a means for locking and unlocking the tampering device. In the preferred embodiment this means is a key fob, however in other embodiments the means may include a touch button combination on the tampering device or arming disarming through smart phone or other wireless mean. Preferentially, it is operationally connected through wireless means and allow the person to arm and disarm the tampering device while it rests atop the persons beverage. However it is contemplated that other means such as tactile manipulation may also be used.

It is contemplated that this device will allow persons to feel comfortable to leave their drinks unattended at bars or other social gatherings where beverages are served without fear of the drink being tampered with (perhaps by the dropping of drugs into the drink). Or alternatively, securely covered while the person, who may be interacting with others, looks away or is otherwise distracted.

In one embodiment of the invention, it is operated as follows: one turns it on, places it atop their beverage and arms the device wirelessly by means of the key fob. Placing the device atop the beverage activates a pressure sensitive switch, which, if armed, will alert both the device and key fob if the pressure is relieved. In an alternative embodiment, 1) the user presses one or more combination buttons on the tampering device, which turns the unit on (preferably indicated by a slow LED blink). 2) The user then enters a personal identification code which is unique to the user and the specific tampering device. If a valid code is not entered, there is a means for indicating arming failure, such as the device turning off. If a valid code is entered there is a visual means for indicating arming success, preferably an indication such as an LED quickly blinking. The tampering device can now be placed onto a glass within a limited time frame, such that motion is not detectable within this time frame. After this, the unit is armed indefinitely.

After placement of the device on the beverage, one may feel free to simply sit with their drink, to roam and interact at the party, go to the bathroom, play games etc. If there is tampering with the device, there are means to indicate tampering. In the preferred embodiment, the key fob will alert and notify the person that the drink may have been tampered with. If this is the case, the person may deal with the situation from a safe distance. In an alternative embodiment, the tampering device itself will visually indicate that tampering has occurred, for example by LED blinking for a predetermined amount of time. In order to turn off the visual indications, one must enter the correct security code within the predetermined time. The unit may also have means to prevent continued attempts at disarming under duress. For example, if the user fails to enter the correct code within three tries, the visual indication stays on for the full duration of the predetermined time and then the unit shuts down.

Finally, as one sits there, or once arriving back at the beverage (assuming that it has not been tampered with) the person may disarm the device with the key fob or tampering device lock and remove the device from their drink.

This invention solves many problems of the above-cited related art which primarily rely on mechanical fastening means which are bulky and unsightly. Further, the device can simply be removed, applied, armed and disarmed unlike the above-cited related art.

### DESCRIPTION OF THE DRAWINGS

FIG. 1 shows a perspective view of the two main components of the invention; the tampering device and the wireless key fob that used to arm and disarm the tampering device.

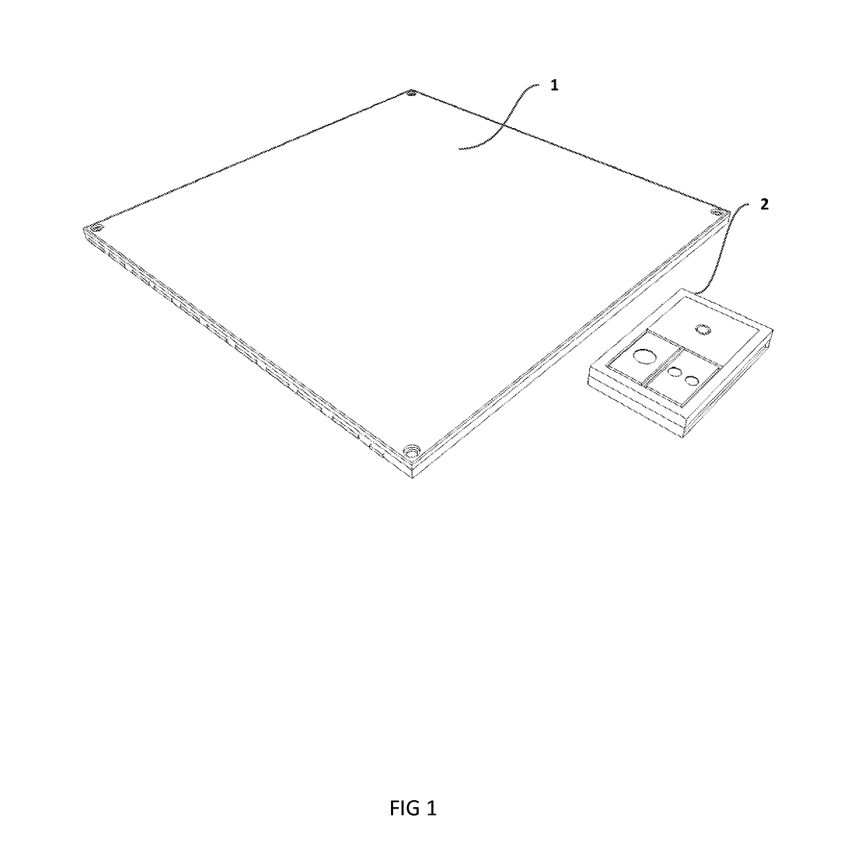

FIG. 2 shows an exploded view of the components of the tampering device.

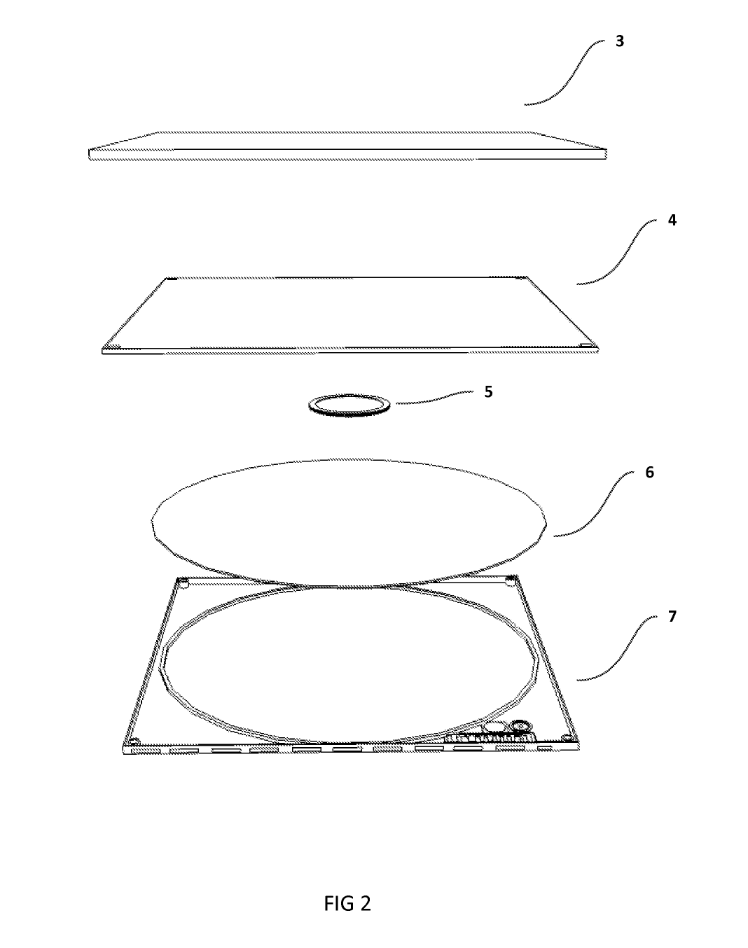

FIG. 3 shows two views of the tampering device interchangeable cover. 3A shows the ventral face and 3B shows the dorsal face.

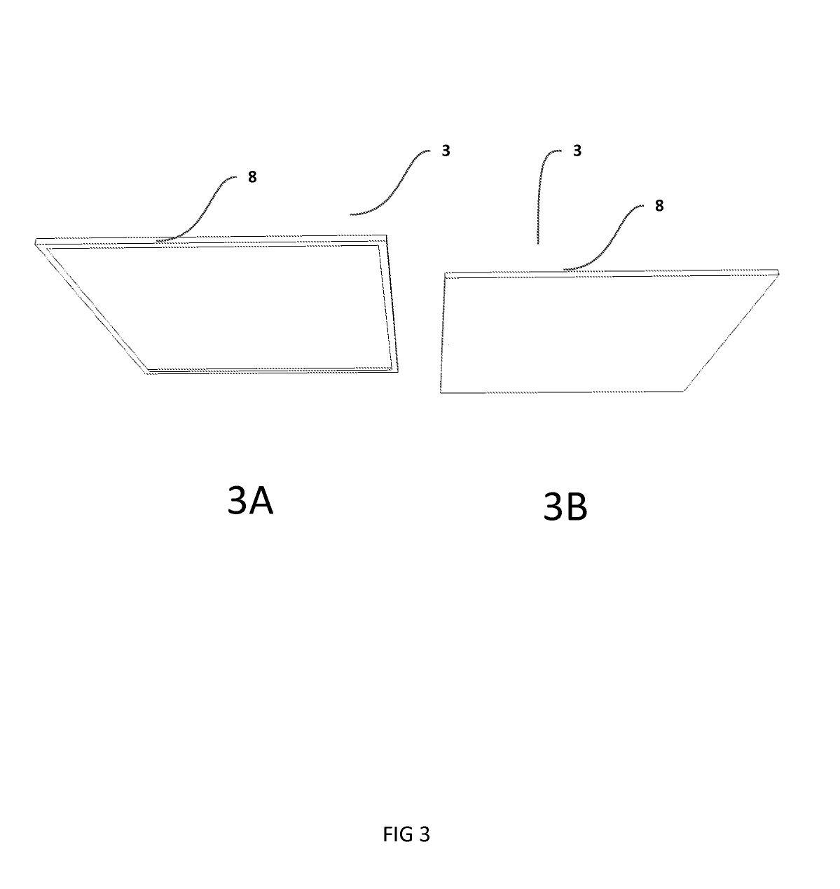

FIG. 4 shows two views of the tampering device top housing. 4A shows the ventral face and 4B shows the dorsal face.

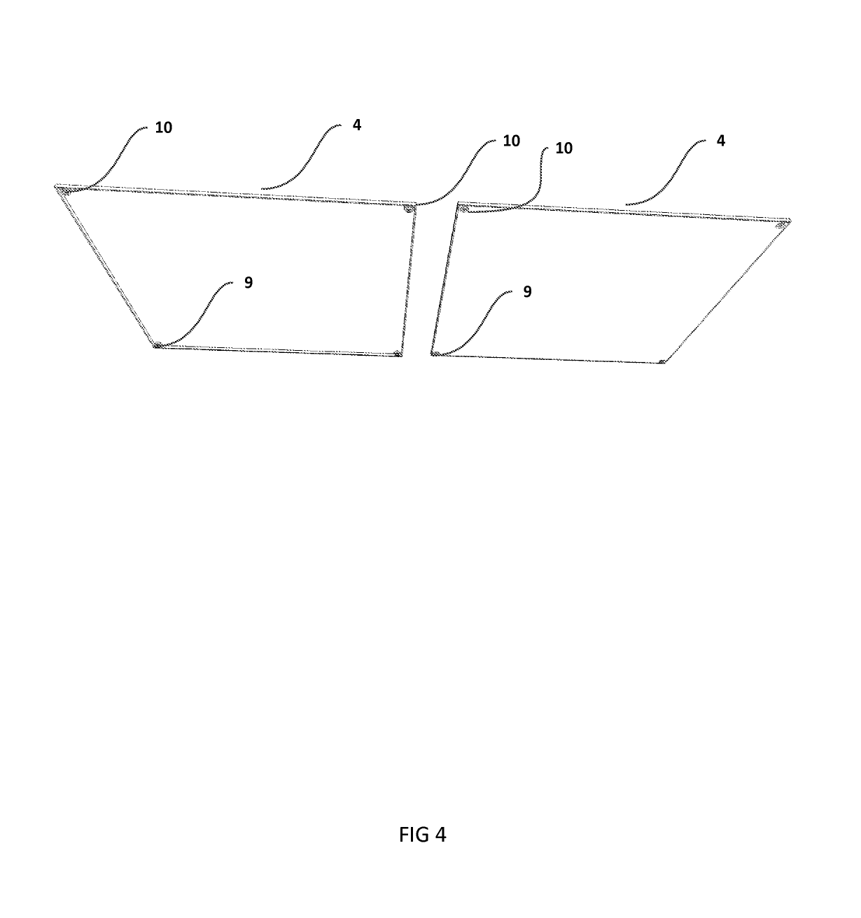

FIG. 5 shows a perspective view of the tampering device bottom housing with the functional internal components inside of it.

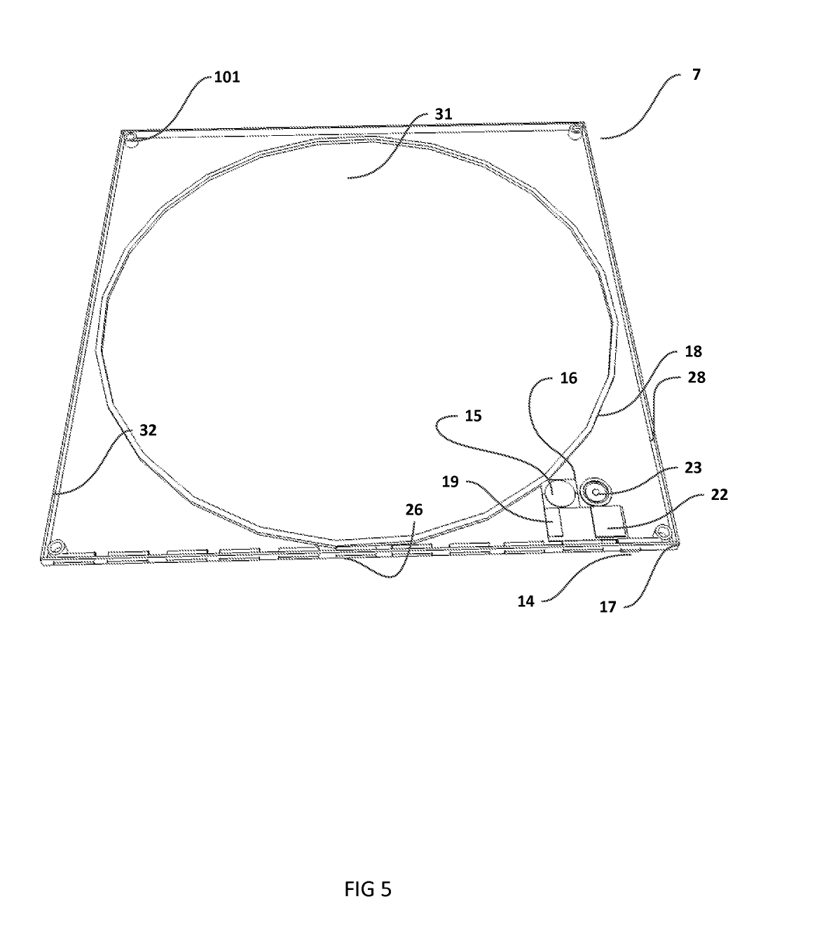

FIG. 6 shows an exploded view of the tampering device bottom housing with the functional internal components inside of it and the tampering device pressure plate which fits inside the tampering device bottom housing pressure plate aperture.

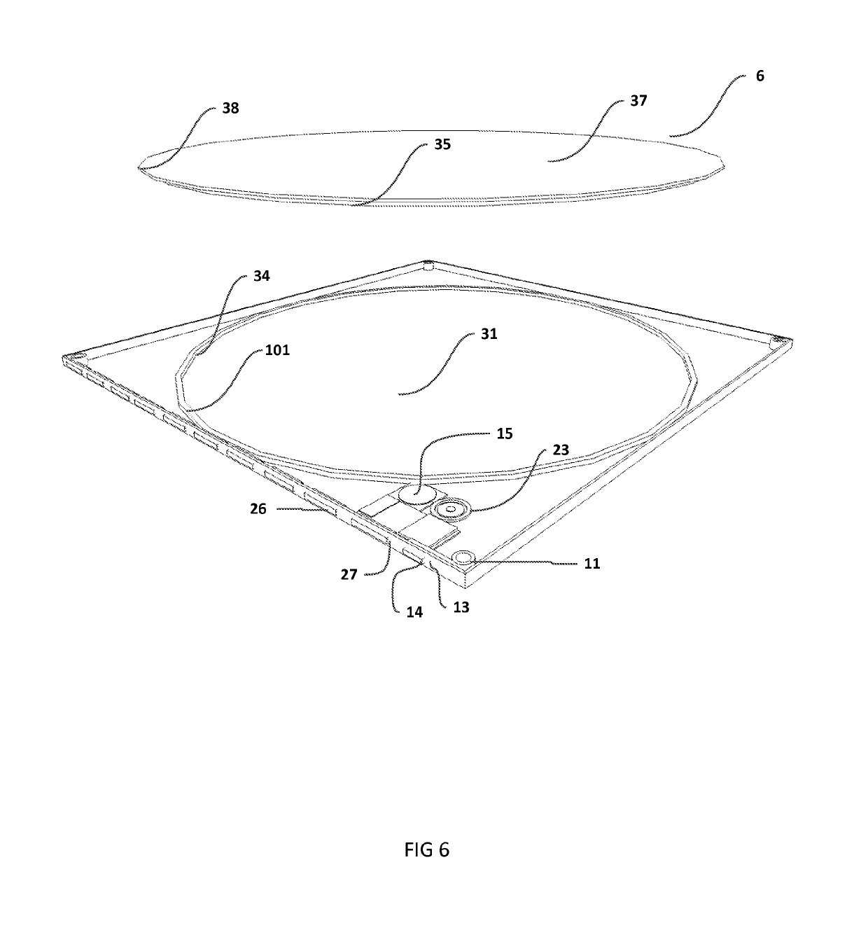

FIG. 7 shows a perspective view of the key fob.

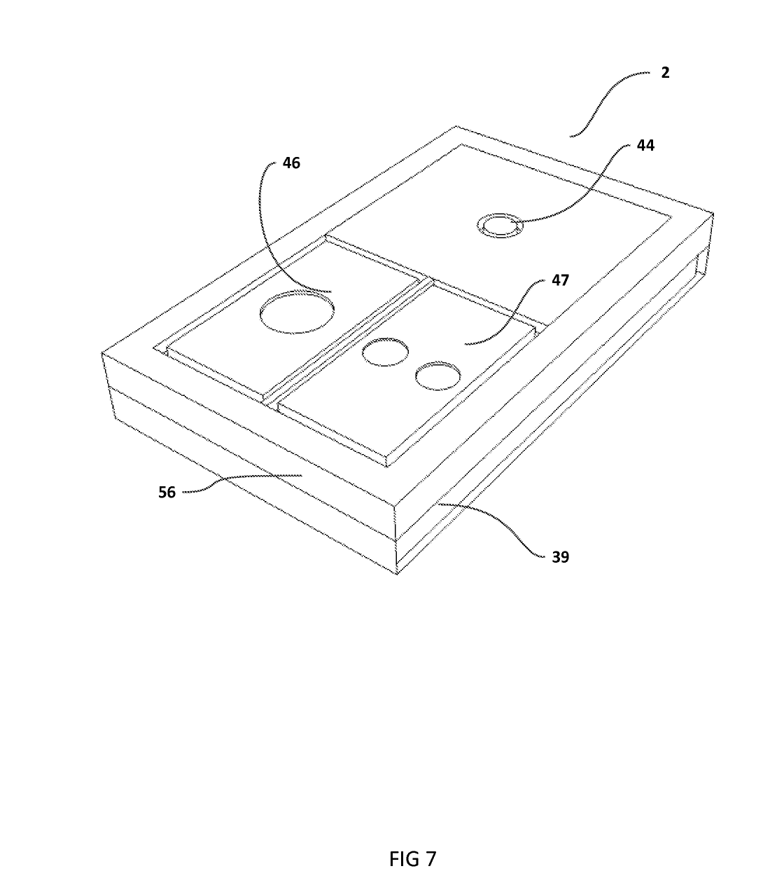

FIG. 8 shows a perspective view of the key fob bottom housing.

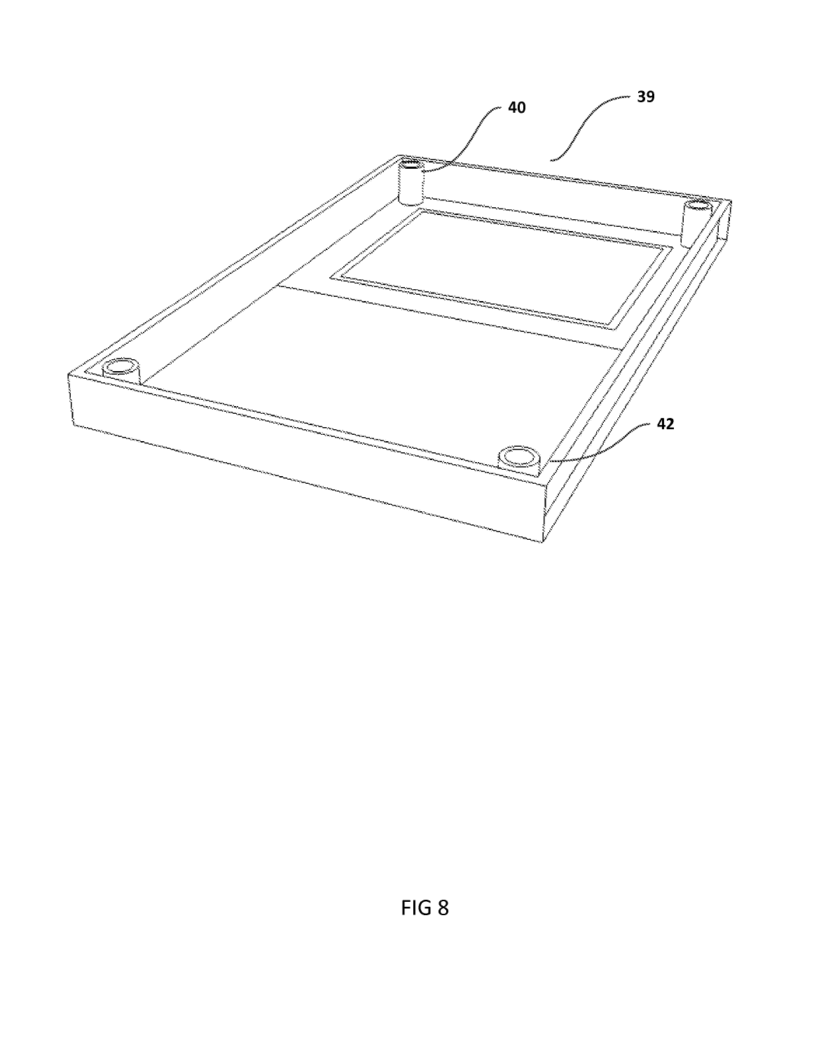

FIG. 9 shows a perspective view of the key fob top housing with functional internal components inside of it.

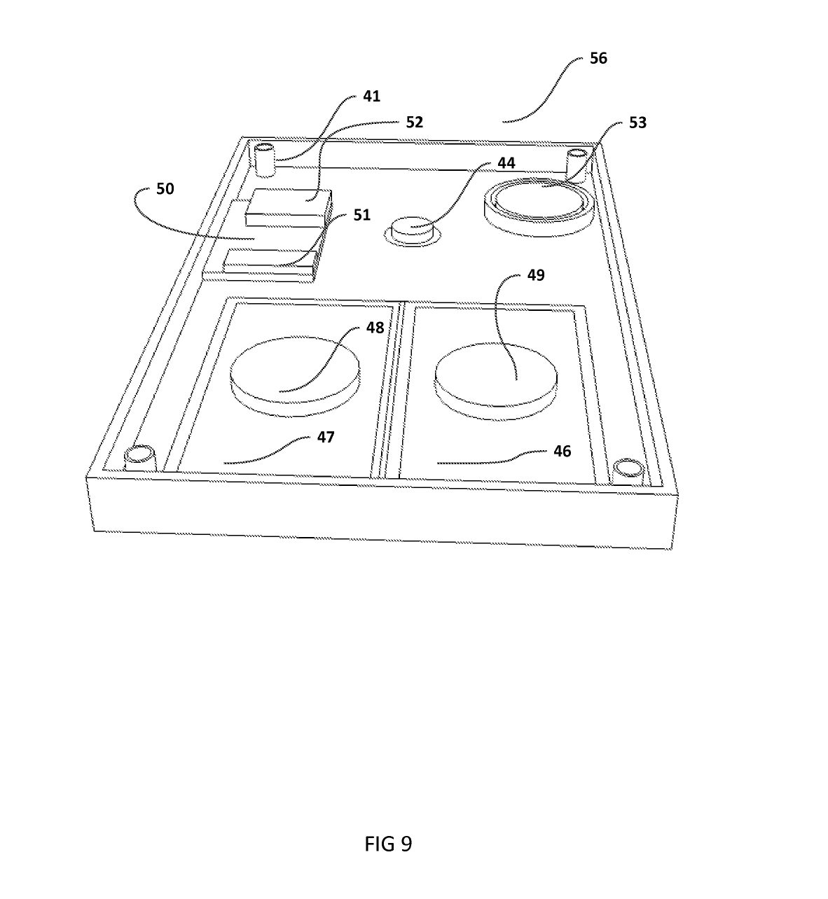

FIG. 10 shows a perspective view of the operation of the invention. 10A shows the placement of the tampering device over top of a beverage holder. 10B shows the arming of the tampering device via radio communication with the key fob.

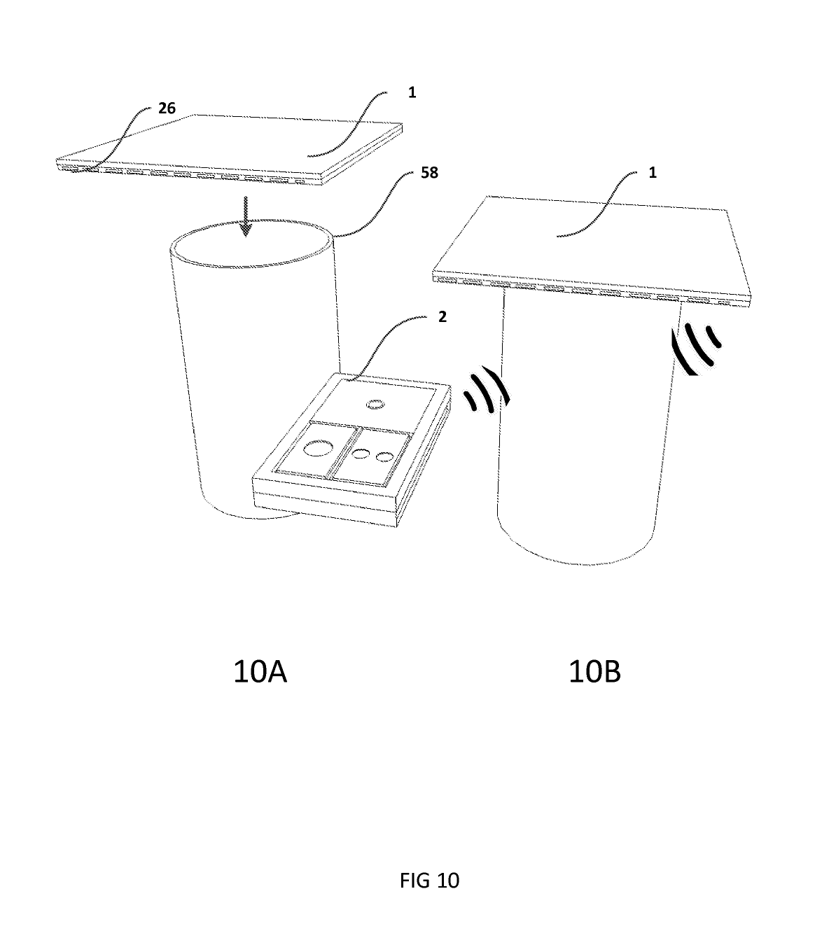

FIG. 11 shows a perspective view of the operation of the invention, wherein the tampering device is moved while armed. It subsequently notifies the key fob and activates alert signals on the device.

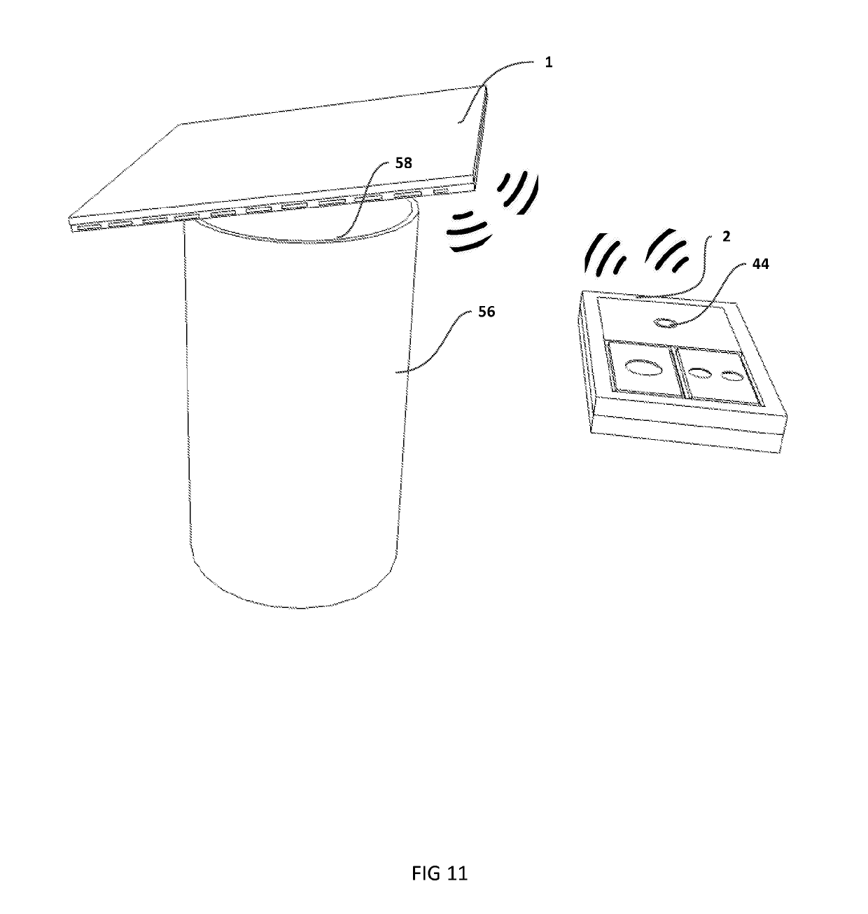

FIG. 12 shows a perspective view of the operation of the invention, wherein the tampering device circular bottle groove is employed to prevent bottle tampering. 12A shows the tampering device circular bottle groove. 12B shows the tampering device balancing on a bottle by use the of the tampering device circular bottle groove.

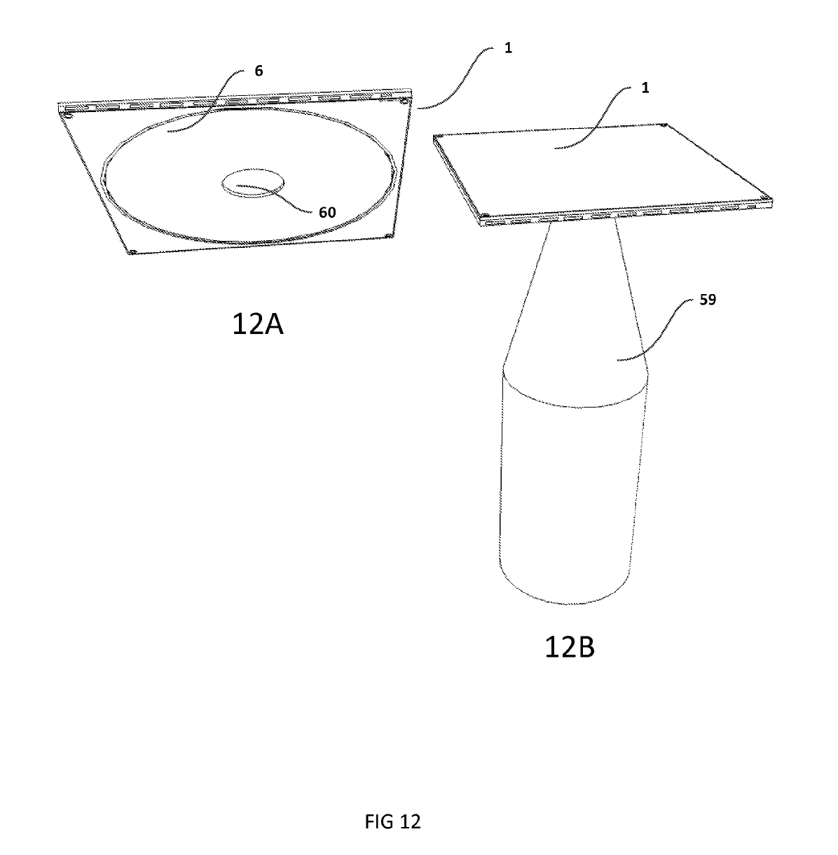

FIG. 13 shows a perspective view of an alternative embodiment of the device, where in the top housing is attached to the bottom housing and an LED and button apertures are present.

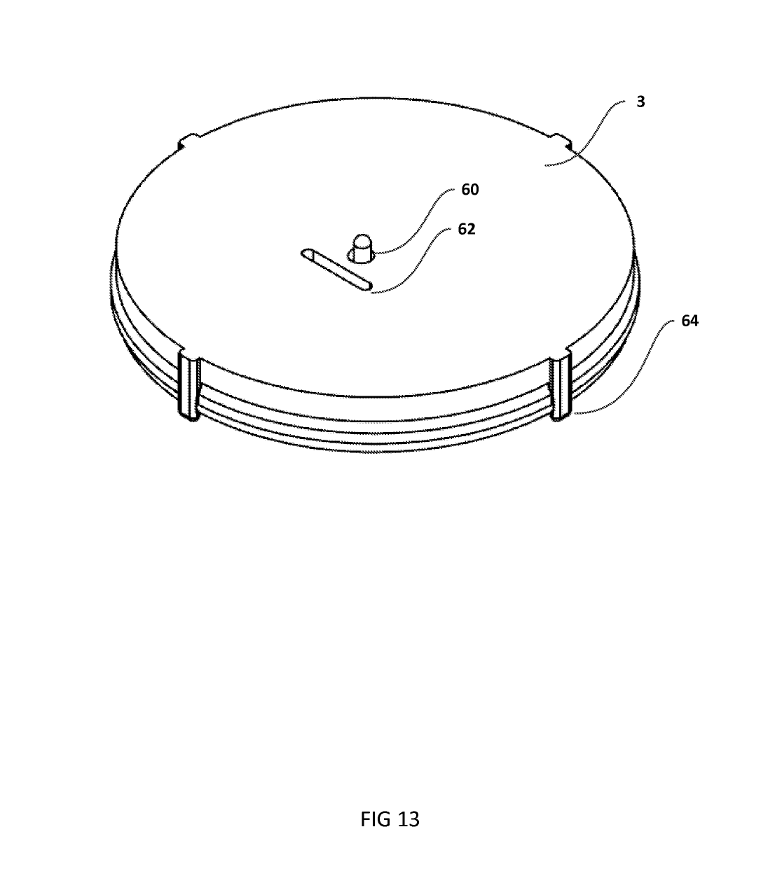

FIG. 14 shows a birds-eye view of an alternative embodiment of the device, where the interchangable attachment, the indicator LED's and the security buttons.

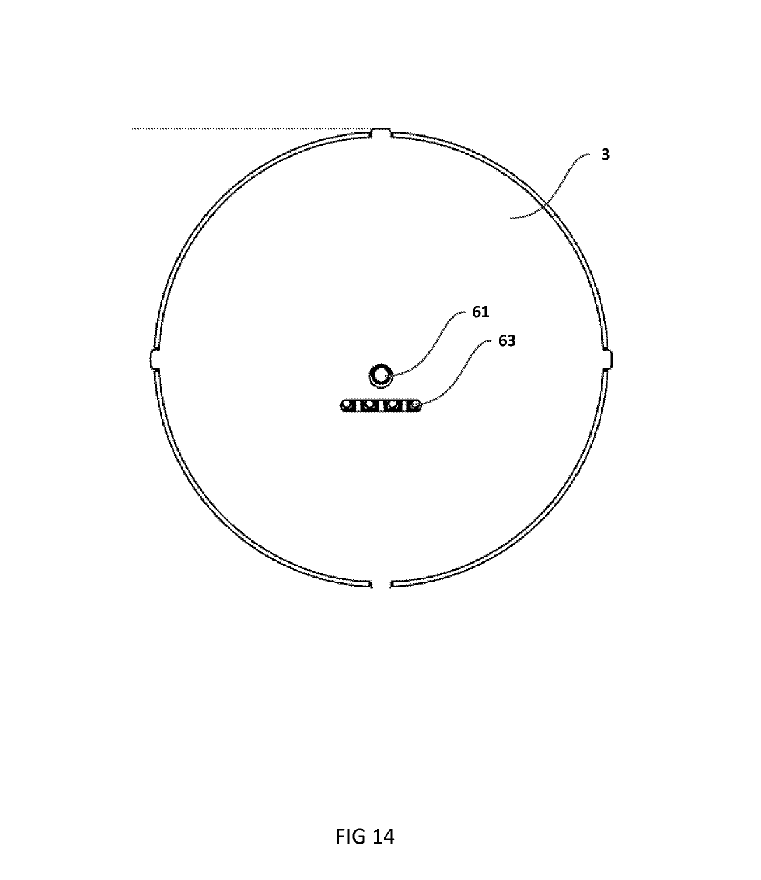

FIG. 15 shows a side exploded view of an alternative embodiment of the device, the interchangable attachment, the bottom housing and internal electrical components.

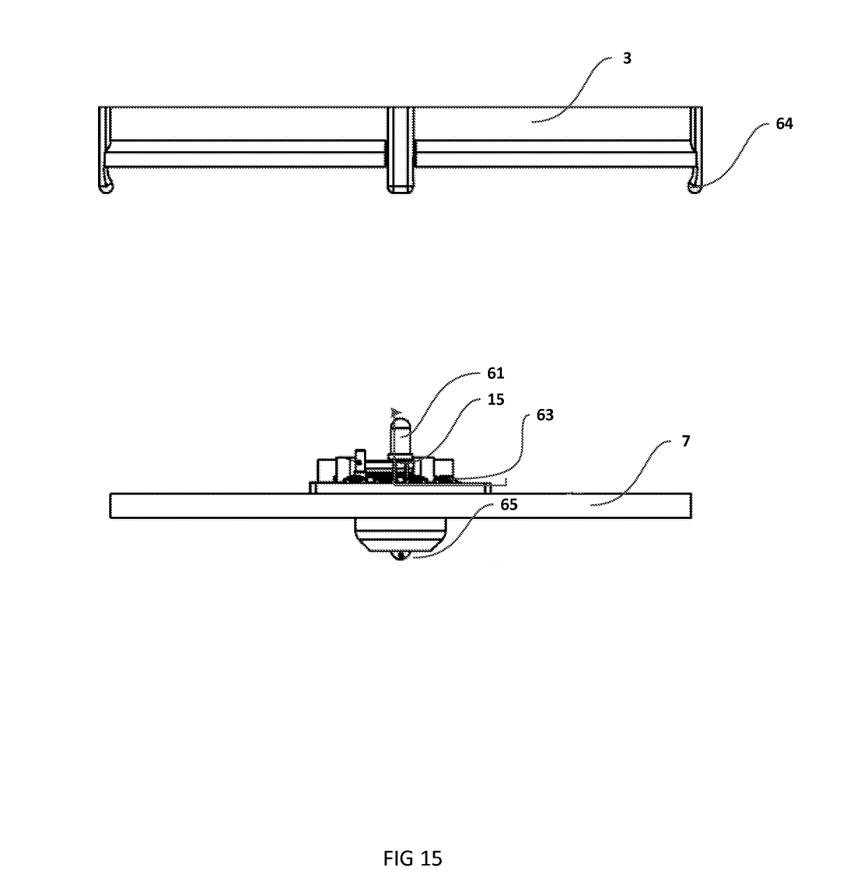

FIG. 15 shows a perspective exploded view of an alternative embodiment of the device, showing the interchangable attachment, the bottom housing, battery and internal electrical components.

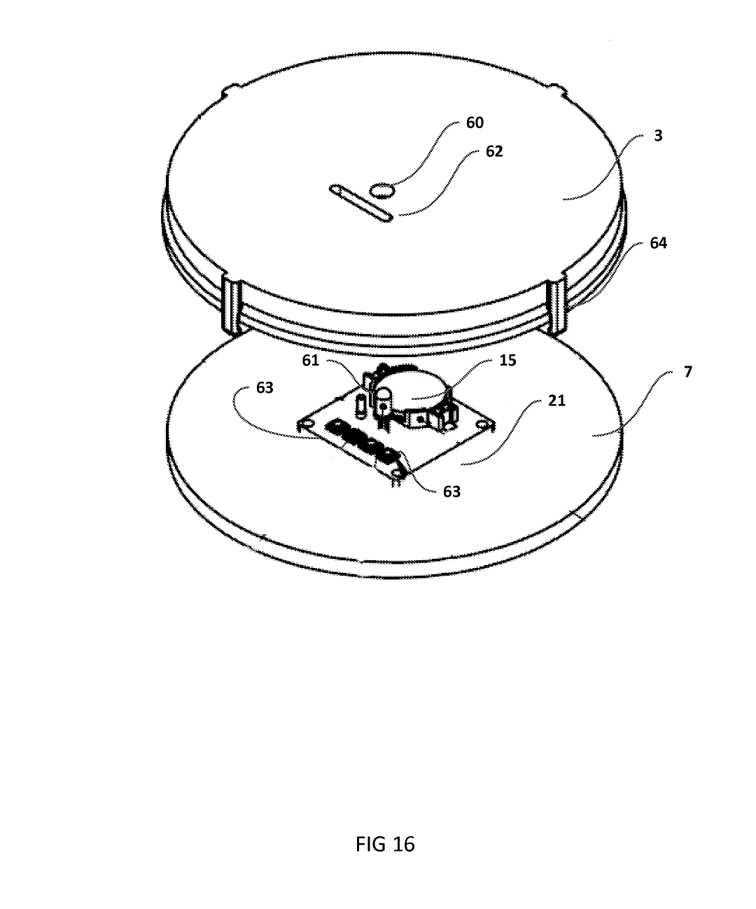

### DETAILED DESCRIPTION OF THE INVENTION

The invention primarily consists of a tempering device 1 with means for arming and disarming said device. In one embodiment, these may be two separate units, a tampering device 1 and a key fob 2. In another embodiment the means for arming and disarming the device may be a tactile combination on the tampering device or a wireless programmatic means to arm disarm the device, such as a smart phone or tablet. The tampering device has means for detecting motion. In one embodiment this is a pressure sensitive component that lies on top of a persons beverage and the is in wireless communication with contact with a key fob. In alternative embodiments, these means may include accelerometers, or capacitive sensors to detect changes in position or motion. Preferably, the key fob is defined is a hand held radio frequency transmitter that operates the tampering device. Though wireless means for communicating with the device may include bluetooth or any electromagnetic signal that is capable of being received by a receiver and processed to indicate an armed or disarmed state. In the preferred embodiment, the tampering device 1 is primarily composed of a tampering device interchangeable cover 3, housing components which in some embodiments may include a tampering device top housing 4 and a tampering device bottom housing 7, a means for detecting motion, preferably a tampering device pressure switch 5 or calibrated accelerometer, and a tampering device/beverage container contact surface which in a preferred embodiment includes a tampering device circular pressure plate 6.

In a preferred embodiment the tampering device interchangeable cover 3 is for decoration of the device and may be composed of a molded material such as acrylic, latex, plastic or resin. It may be square, rectangular or round as long as the tampering device interchangeable cover 3 is capable of operably attaching/detaching from the rest of the tampering device, and/or he tampering device top housing 4 and tampering device bottom housing 7. It can be both affixed and removed from the tampering device bottom housing 7 by encompassing the tampering device interchangeable cover 3 around the tampering device top housing lateral outside edge 8, in a preferred embodiment, or may in alternative embodiments interact with the bottom housing or other surfaces of the tampering device. In alternative embodiments, the interchangable cover may serve as the top housing. In yet other alternative embodiments, the interchangable cover may include apertures for visual indicators (such as LEDS) or combination buttons that can be pressed to arm/disarm the device. In yet other embodiments, the interchangable covers may have gripping means on the side for grasping the tampering device. In yet other embodiments, the housings and interchangable cover may be square shaped, wherein in other it may be circular-shaped.

In a preferred embodiment, this affixing and removal of the tampering device interchangeable cover 3 is accomplished via constrictive forces from the tampering device interchangeable cover gripping edge around the tampering device top housing lateral outside edge. In other embodiments the tampering device interchangeable cover 3 may be affixed via other means such as magnetic forces, by design (for example, a modified tampering device top housing 4 designed to receive and remove the tampering device interchangeable cover 3), screws, clasps, snaps or adhesive. 4

In the preferred embodiment, the tampering device top housing 4 protects the internal components of the device, forms the shape of the device and contributes to the design of the device. Similar to the tampering device interchangeable cover 3, the tampering device top housing 4 may be composed of a molded material such as acrylic, latex, plastic or resin. Also, similar to the tampering device interchangeable cover 3, the tampering device top housing 4 and tampering device bottom housing 7 are of similar shape and dimension. In some embodiments, the top housing has apertures 60, 62 for dorsal visual indicators of armament 61 and tactile means for arming/disarming of the tapering device, such as combination buttons 63

Preferably, the top housing (and/or interchangable cover) has means for attaching to the bottom housing. In a preferred embodiment, the square shaped tampering device top housing 4 has tampering device top housing corners 9 with tampering device top housing corner screw receptacles 10 where in screws insert through the tampering device top housing corner screw receptacles 10 and into the tampering device bottom housing corner screw receptacle 11 in the oppositely facing tampering device bottom housing corner 12. In alternative embodiments, these means for attachment again may be other magnetic forces, structural, i.e. by design (for example, a modified tampering device top housing 4 designed to receive and remove the tampering device interchangeable cover 3), screws, clasps 64, snaps or adhesive.

The tampering device bottom housing 7 is used to protect the internal components of the device, form the shape of the device and contribute to the design of the device. Similar to the tampering device interchangeable cover 3 and the tampering device top housing 4, the tampering device bottom housing 7 may be composed of a molded material such as acrylic, latex, plastic or resin. In the primary embodiment, the tampering device bottom housing 7 has additional molded elements that contribute to the function of the device. For example, the tampering device bottom housing 7 may have structural means that allow for operation of the device. For example, means for allowing the powering of the device, such as a tampering device bottom housing power switch aperture 13 within which fits the tampering device bottom housing power switch 14. In this embodiment, this is so the user of the device can power the device on or off, and may be a rocker switch, a sliding switch or other types of common on-off switches. In alternative embodiments, the structural means that allow for operation of the device may include one or more apertures for beverage illumination, such as an aperture for an LED operably connected to the integrated circuit so that the tampering device may illuminate the beverage when armed/disarmed.

In the preferred embodiment, the tampering device bottom housing power switch 14 should be small enough to fit within the design of the invention and to be virtually hidden so as to be aesthetically pleasing for the user of the invention. Similarly, in other embodiments, the power switch may not be visible at all and the device may be powered on through other means, such as entering of a combination on the tampering device or detection of motion, or wireless means. Any means for turning the power on or off would operably be connected to a tampering device battery 15 which preferably is removably affixed to the tampering device bottom housing 7 by a tampering device battery holder 16. In the primary embodiment the tampering device battery 15 is small and circular and lies within an area between the tampering device bottom housing corner 17 and tampering device bottom housing lateral inside edge and the tampering device bottom housing pressure plate aperture outside edge 18. This region is herein termed the tampering device bottom housing triangle-shaped space 20. In other embodiments the tampering device battery may reside on the pcb board, or be affixed to the top housing, though a priority is placed on the economics of space within the device.

In the preferred embodiment, the tampering device battery 15 is operably connected to the tampering device bottom housing power switch 14 and the tampering device PCB board 21 wherein additional circuitry is present used to operate the device when powered. In alternative embodiments, the battery may not be connected to any user operable on/off switch, but rather operably connected to combination or wireless input allowing management of the power of the tampering device. In the preferred embodiment, the tampering device PCB board 21 is operably attached to a tampering device integrated circuit 19 and a means for arming siarming the device. In one embodiment, this is a tampering device radio frequency transmitter 22, wherein the tampering device integrated circuit 19 performs the logical operations of the device and controls the performance of the tampering device radio frequency transmitter 22. In other embodiments, the tampering device integrated circuit 19 performs the logical operations of the device and controls the performance of tactile combination input. In some embodiments, the tampering device integrated circuit 19 may be operably attached to a tampering device audio miniature speaker 23 or other audio means for indication of the armed/disarmed/safe or duress state of the device. This tampering device audio miniature speaker 23 may be encompassed within a tampering device within a audio miniature speaker holder 24. Further, sounds emitted from tampering device may be emitted through tampering device audio miniature speaker apertures 25 that may be present on the tampering device bottom housing 7, interchangable cover or top housing.

The tampering device integrated circuit 19 (or integrated circuit controller) is also operationally attached to one or more tampering device light emitting diodes (LED) 26 and can control the presence or absence of light emission from the tampering device light LEDS 26, the frequency of emission from the tampering device LED 26, and/or coordination of differential frequencies of emission of the tampering device LEDS 26 amongst or between one another. The placement of these LEDS may be positioned dorsal, ventral or lateral to the integrated circuit, through apertures in any of the housing components. For example, in the preferred embodiment, the tampering device light LEDS 26 are placed within one or more tampering device bottom housing LED aperture 27 present on the tampering device bottom housing 7. The tampering device bottom housing LED apertures 27 allow insertion of the tampering device LEDS 26 through the tampering device bottom housing lateral outside edge 28 into the tampering device bottom housing lateral inside edge 32. Thus the emission portion of the tampering device LEDS 26 can been seen from the outside of the device, and parallel to the tampering device bottom housing lateral outside edge 28. In another embodiment, the LEDs may be present on one or more ventral apertures in the bottom housing and may serve to illuminate the beverage 64. In yet another embodiment, one or more LEDs may be present themselves through top housing (cover) apertures in order to indicate armament, power, duress or other operational states of the device.

In one embodiment of the device, the connection portion of the tampering device LEDS 26 are medial to the tampering device bottom housing lateral inside edge 32 and operably connect to the tampering device PCB board 21 and tampering device integrated circuit 19 by electricity (wires or circuit board). It is contemplated that the tampering device bottom housing LED apertures 27 will be present on one or more tampering device bottom housing lateral outside edge 28, wherein the number of tampering device bottom housing LED apertures 27 may vary according to aesthetic or economic considerations. In this embodiment, because the device is placed flat on a beverage when operated, numerous tampering device bottom housing LED apertures 27 on each of the tampering device bottom housing lateral outside edges 28, will give the user of the device a wider vantage point to assay having it's signal when tampered with. However, in other embodiments it may be advantageous to exclusively (or in addition to) place the tampering device LEDS 26 and tampering device bottom housing LED apertures 27 on other surfaces such as tampering device bottom housing ventral face 30, the tampering device top housing lateral outside edge 8, or the tampering device top housing dorsal face 33, as stated in the previous paragraph.

On the bottom of the tampering device, preferably the middle of the tampering device bottom housing 7 is a barrier means for protecting the beverage, sealing the beverage, and/or triggering an armed state of the device. In one embodiment, this is a tampering device bottom housing pressure plate aperture 31 abutted by the tampering device bottom housing pressure plate inside edge 34. In this embodiment, the tampering device bottom housing pressure plate aperture 31 fits the tampering device circular pressure plate 6 and is used to detect changes in physical pressure when the device is on. Structurally, this embodiment's tampering device circular pressure plate 6 has a tampering device circular pressure plate lateral edge 35 that fits within the tampering device bottom housing pressure plate inside edge 34. The function of the tampering device circular pressure plate lateral edge 35 is to positionally constrain the tampering device circular pressure plate 6 during mechanical movement to the dorsal/ventral plane. Therefore, in this embodiment, when the tampering device circular pressure plate 6 is placed inside the tampering device bottom housing pressure plate aperture 31, the tampering device circular pressure plate ventral face 36 is facing outside the device and can be interacted with by the user. The tampering device circular pressure plate dorsal face 37 is held within the confines of the device. In alternative embodiments, without a pressure sensitive trigger, an accelerometer may be used as a detection mechanism such that a small edge (or none) may be necessary.

In one embodiment, the placement of the tampering device circular pressure plate ventral face 36 onto the rim of a beverage mechanically depresses the tampering device bottom housing 7 by the tampering device circular pressure plate hidden lip 38, which is circumferentially larger than the tampering device bottom housing pressure plate aperture 31 and thus restricts the tampering device circular pressure plate 6 from falling out of the device. The tampering device circular pressure plate dorsal face 37 is operationally attached to a tampering device pressure switch 5 which is operationally connected to the tampering device integrated circuit 19. In the primary embodiment, the tampering device pressure switch 5 is a spring loaded actuator switch, wherein changes in the spring constant trigger signal changes to the tampering device integrated circuit 19. In other embodiments, the tampering device pressure switch 5 is a pressure sensor, wherein changes in the differential will signal changes to the tampering device integrated circuit 19. In this latter embodiment, tampering device circular pressure plate 6 may not be a moving piece as in the case of a spring loaded actuator switch and thus maybe affixed to the tampering device bottom housing 7. In yet other embodiments, the device may have an elastic lead or covers with piezoelectric leads that detect movement and alarm when removed. In yet another embodiment, a motion or position sensor may be inserted into the beverage to detect disturbance using a similar wireless detection method such as RF signals or bluetooth. In yet other alternative embodiments, a timing mechanism in coordination with an accelerometer may be used to set a “stable state”, wherein disruption of stable state alarms the user.

The tampering device additionally has user means for arming/disarming the device. In one embodiment, this is a mechanically separate portion of the invention, the key fob 2 and in alternate embodiments of the invention the means are included within the tampering device unit. In the key fob embodiment, similar to the tampering device 1, it has housing, such as a key fob bottom housing 39 and a key fob top housing 56. In this embodiment, the key fob top housing 56 has two button apertures, the key fob housing unarmed device button aperture 44 and the key fob housing armed device button aperture 45, which hold spring loaded buttons, the key fob disarm device button 46 and the key fob arm device button 47. In this embodiment, the key fob bottom housing 39 has a key fob battery access aperture 54 used for insertion and replacement of the key fob battery 53 for the key fob 2. In addition, in this embodiment, the key fob bottom housing 39 is molded to include a key fob battery holder 57 used to securely ensconce the key fob battery 53.

In this embodiment, the key fob top housing 56 and key fob bottom housing 39 have means by which to securely fasten to one another and enclose the internal components of the key fob 2. In the primary embodiment the key fob top housing 56 and key fob bottom housing 39 are combined to another by insertion of one or more screws into key fob bottom housing screw receptacle 40 and key fob top housing screw receptacle 41. In other embodiments, the key fob top housing 56 and key fob bottom housing 39 may be designed such that can detachably combine through mechanically operated snaps at the key fob bottom housing dorsolateral edge 42 and the key fob top housing ventrolateral edge 43.

In this embodiment, the internal components of the key fob include a key fob LED 44, a key fob arm device button 47, a key fob disarm device button 46, a key fob arm device button spring loaded switch 48, a key fob disarm device button spring loaded switch 49, a key fob PCB board 50, a key fob integrated circuit 51, a key fob radio transmitter 52, and a key fob battery 53. The key fob arm device button 47 and attached key fob arm device button spring loaded switch 48 and key fob arm device button 47 and attached key fob disarm device button spring loaded switch 49 are operationally connected to the key fob integrated circuit 51.

In the key fob embodiment, similar to the tampering device 1, the key fob integrated circuit 51 is housed on the key fob PCB board 50 and is also operationally connected to the key fob battery 53 for power. Additionally, the key fob integrated circuit 51 is operationally connected to on more key fob LEDS 44, located within the key fob top housing LED aperture 55 which are used to notify the user of the state of the tampering device 1 as armed or disarmed. Further, the key fob integrated circuit 51 is operationally connected to the key fob radio transmitter 52 which is used to communicate with the tampering device 1.

For the key fob embodiment, in order to use the invention, the user has both the tampering device 1 and the key fob 2 on the persons. When the user wants to walk away from their beverage 56, first they turn on the tampering device 1 by manipulating the tampering device bottom housing power switch 14 so that the device is powered on. Notification that the tampering device 1 is on, may be signalled to the user by light emission from one or more of the tampering device LEDS 26 or an audible sound that is emitted from the tampering device audio miniature speaker 23. In addition, the key fob LED 44 may then emit light, notifying the user that the tampering device is on and that the key fob 2 is in radio communication with the tampering device 1.

Subsequently, the user will hold the tampering device 1 so that the tampering device top housing dorsal face 33 is up (The tampering device top housing dorsal face 33 may or may not be adorned with the tampering device interchangable cover 3). Next the user, lowers the tampering device 1 such that the circumference of the beverage holder lip 60 is entirely within the tampering device bottom housing pressure plate aperture 31. Still lowering the tampering device 1 over the beverage holder, such that the tampering device circular pressure plate ventral face 36 of the tampering device circular pressure plate 6 comes into contact with the beverage holder lip 58 and the weight of the tampering device 1 depresses the tampering device circular pressure plate 6 and activates the tampering device pressure switch 5. The activation of the tampering device pressure switch 5 activates the tampering device integrated circuit 19 to send a signal to the key fob 2 via the tampering device radio frequency transmitter 22 to the key fob radio transmitter 52 that the tampering device 1 has the potential for being armed.

Importantly, the tampering device bottom housing pressure plate aperture outside edge 18 conceals the beverage holder lip 58 from top-down visual contact from potential perpetrators. Additionally, the beverage holder lip 58 forms a complete seal with the tampering device circular pressure plate ventral face 36. If a perpetrator tried to put any substances within the users beverage 56, they would necessarily have to access the beverage 56 via the now sealed beverage holder lip 58. In order to do this, they would need to lift the tampering device 1 such that the weight of the tampering device 1 is now no longer capable of activating the tampering device pressure switch 5, which would send a signal to the tampering device integrated circuit 19.

In addition, to placing the tampering device 1 on top of beverage such as a glass the tampering device pressure plate 6 also has a tampering device pressure plate circular bottle groove 60. The tampering device pressure plate circular bottle groove 60 is located at the center of the balance for the tampering device in the middle of the tampering device pressure plate 6. This allows the user to easily locate the center of balance for placement of the tampering device 1 onto smaller lipped beverage holders such as a bottle 59.

Thus, after lowering the tampering device 1 onto the beverage holder lip 58 and forming a seal, the user may then arm the tampering device 1 via communication with the key fob 2. This is done by pressing the key fob arm device button 47 which subsequently communicates via the key fob radio transmitter 52 to the tampering device radio frequency transmitter 22 that the tampering device pressure switch 5, may not be altered (e.g. the tampering device 1 is an armed state). This activation of this armed state may be made visually apparent by indication on either or both the key fob LED(s) 44 or the tampering device LED(s) 26. Once in the armed state, the user is free to walk around within the communication range of the key fob radio transmitter 52 and tampering device radio frequency transmitter 22 knowing that the beverage is safe although unattended. 5

If the tampering device pressure switch 5 is activated once in the armed state, or the tampering device bottom housing power switch 14 is turned off then several things may a occur. The user may be notified on the key fob 2 that the tampering device 1 has been moved, via key fob radio transmitter 52 and tampering device radio frequency transmitter 22 communication. The key fob LED 44 may make a visual indication of this change. Also, the tampering device 1 may indicate a disturbance by flashing of the tampering device LEDS 26 or making an audible indication via the tampering device audio miniature speaker 23. Once notified of tampering the person may deal with the situation at hand, and from a safe distance.

If the tampering device pressure switch 5 is not activated once in the armed state and the user has returned to the beverage 56 and they would like to continue having a drink. They must first disarm the tampering device 1 by pressing the key fob disarm device button 46, which will communicate to the tampering device via key fob radio transmitter 52 and tampering device radio frequency transmitter 22 communication that it if the tampering device pressure switch 5 is activated than an alarm should not be signaled. The user may then continue drinking their beverage knowing it was not tampered with.

Besides the key fob embodiment, there are alternative embodiments, where in the device is armed and disarmed without wireless means. In this embodiment, apertures 60,62 through the top housing/cover allow the presence of at least 3 buttons 63 and at least 1 LED 61. The buttons 63 and LED operably connected to one or more integrated circuit that allow the processing of user mediated combination of button presses (such as sequences: 3,4,3,2,2,1,3,2,4,1,1 etc.) to act as a security lock for the tampering device. These button combinations can be used to operate several necessary features, relevant to the operation of the device throughout its life time. For example, these buttons 63 can be used to for out of the box, initial security code programming. In order to do this one would do as follows, 1) The device, initially stored off allows the user to presses any button, which in turn would make the LED 61 solid. 2) The user would get a specific programming code sequence from the instructions supplied with product, in order to initialize he device. 3) The user would then enter this specific button sequence which turn would transform the LED 61 from solid to slow blink, indicating the device is now turned on and is ready to receive user's own code.

In one embodiment of the device, 4) the new user code must now be entered starting within 2 seconds or else unit turns back off and must be re-initialized. In alternative embodiments, these times may vary 5) Next the user would enter a code sequence on the 4 buttons 63, which preferably would include a minimum of six key presses, to produce a better/stronger code. Though, in alternative embodiments with more buttons, these requirements may be more. 6) After time of last key press, the unit assumes code entry has completed and LED 61 goes on solid for 5 seconds, then off as it permanently saves the users code. The unit is now personalized and ready to be used.

Another operation allowed by the button means for arming/diarming the device is the normal usage of the device follows: 1) The user enters their personal user code starting within 10 seconds If the wring code is entered the LED goes out and unit is turned OFF, if the right code is entered the LED would now be now fast blinking indicating that it recognized user. 2) Next the device must be placed on beverage within 5 seconds. 3) After being placed on the beverage and 5 second timeout completes, and the LED goes out. After this, 4) the device will remain armed indefinitely if it is left on a glass without being moved/tilted. 5) If the unit is moved/tilted, then the LED goes on in fast blinking mode for maximum of 15 minutes, wherein the device must receive correct security code sequence in order to turn itself off before normal 15 minute timeout. If the user fails to enter correct code within three tries, then the device stays on for full 15 minutes with fast LED blinking regardless. 6) If the user is unable to turn the unit off using his/her personal security code, then device may have been replaced with a different one by someone else 7) The device will automatically turn off/reset under all conditions 15 minutes after being alarmed by moving/tilting. 8) Finally if the correct code is entered the device is disarmed.

It is appreciated that there can be many variations and embodiments of this invention and the above stated are exemplary.

1) I claim a device for beverage protection wherein said device comprises;
a removable battery-powered unit that forms a security barrier with the rim of beverage container wherein said unit comprises electronic components with means for processing logic for arming and disarming said unit and visual means for communicating operating states.

2) The device of claim 1 wherein said unit comprises housing, wherein said unit has a height of at least an eighth of an inch but not more than one inch.

3) The device of claim 2 wherein said unit has a beverage container bottom contact area that is at least 9 inches squared but not more than 36 inches squared.

4) The device of claim 3 where in said electronic components operably connect to light emitting visual indicators contained within said unit.

5) The device of claim 4 wherein said visual indicator is an LED, OLED or LCD.

6) The device of claim 5 where in said electronic components are capable of receiving input by interaction with the user.

7) The device of claim 6 wherein said electronic components process said input and powers on one or more of said visual indicators in order to indicate the operating status of the unit.

8) The device of claim 7 wherein said operating status of the unit communicated by said visual indicators may be an uninitialized state, an initialized state, a ready to be used state, on state, off state, secure state, armed state, disarmed state or under duress state.

9) The device of claim 8 wherein said armed state comprises the unit being placed atop a beverage container and said electronic components are operably connected to sensors that monitor movement of the unit, wherein movement of said unit induces powering on of visual indicators indicative of said duress state.

10) The device of claim 9 wherein said sensors are accelerometers, pressure sensors, or capacitative sensors.

11) The device of claim 10 wherein said operating status of the said unit is operated by keypresses one at least one or more buttons present on the unit.

12) The device of claim 11 wherein there are buttons present on the unit, upon which presses of said buttons function as a means for said user to input a security code, wherein said security code is logically processed by one or more electrical components for allowing access of said user to said states of operation for said unit.

13) The device of claim 12 wherein there are minimum of four of said buttons and a maximum of eight of said buttons.

14) The device of claim 13 wherein said buttons are present on the top of the unit.

15) The device of claim 14 wherein said unit comprises at least one visual indicator on the top of the unit.

16) The device of claim 15 wherein said unit comprises at least one visual indicator on the bottom of the unit.

17) The device of claim 10 wherein said operating status of the unit is controlled by a wireless controlling device that communicates with said electronic components on said unit by signals that comprises by means of a transmitter and receiver on both said unit and said controlling device.

18) The device of claim 17 wherein said operating status of said unit is communicated to said user within wireless range but not within visual range of said unit.

19) The device of claim 18 wherein said wireless controlling device is a key fob, smart phone or tablet.

20) The device of claim 19 wherein said signals are radio, bluetooth, or wifi signals.
